(19) United States
(12) Patent Application Publication
(10) Pub. No.: US 2006/0082716 A1
(43) Pub. Date: Apr. 20, 2006

(54) Method of producing liquid crystal cells on a silicon substrate and corresponding cells

(76) Inventors: Hugues Lebrun, Coublvie (FR); Saverio Arfuso, Vourey (FR); Jean-Claude Lehureau, Genevieve Des Bois (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/539,806

(22) PCT Filed: Dec. 4, 2003
(86) PCT No.: PCT/EP03/50944

§ 371 Date: Jun. 20, 2005

(30) Foreign Application Priority Data
Dec. 20, 2002 (FR) 0216360

(51) Int. Cl. G02F 1/1339

(52) U.S. Cl. 349/153

(57) ABSTRACT

In a collective method of fabricating liquid crystal cells on a silicon substrate, a sealing frame for assembling a back electrode substrate and an active matrix circuit silicon substrate is disposed so as to overlap external contact pads of the active matrix circuit and a portion of a connection mechanism provided on the back electrode substrate including the connection mechanism is overhanging with respect to the active matrix substrate, allowing the connection to an external control device.

The present invention belongs to the field of the fabrication of liquid crystal cells, on a silicon substrate, according to a technology generally designated by the acronym LCOS (Liquid Crystal On Silicon). It relates more especially to a process for fabricating such cells according to collective methods. In a known manner, a collective method of fabricating liquid crystal cells on a silicon substrate comprises the obtaining of a silicon wafer, on which has been formed a plurality of active matrix circuits, these circuits being disposed on the wafer according to a substantially orthogonal array.

The collective method then comprises the following steps, well known to the person skilled in the art:
formation on a transparent support, generally glass, of a plurality of back electrode patterns or circuits made of conducting and transparent material, according to an orthogonal array;
deposition on the silicon wafer and on the transparent support, on each circuit, of a layer of organic material, that will be rubbed away, to form the microstriations which will allow the alignment of the liquid crystals;
formation of a peripheral seal or sealing frame, not completely closed, on the perimeter of each active matrix;
assembly of the transparent support to the silicon wafer the one on the other, each back electrode circuit facing an active matrix circuit, and the sealing frame producing a space between the two circuits;
precutting of the silicon wafer over 50 to 90% of the thickness of the wafer, by sawing in water from the rear face, a leaktight seal, for example a bead of epoxy adhesive, having been previously formed on the perimeter of the support-wafer assembly;
and precutting of the glass support, either by sawing over 50 to 95% of the thickness, or by a stylus forming grooves (scribing);
drying and individual separation of the cells, by suitable mechanical means such as a guillotine, or manually;
introduction of the liquid crystals into each cell, which will fill the cavity of each cell through the opening made in the sealing frame, then hermetic plugging of the opening.

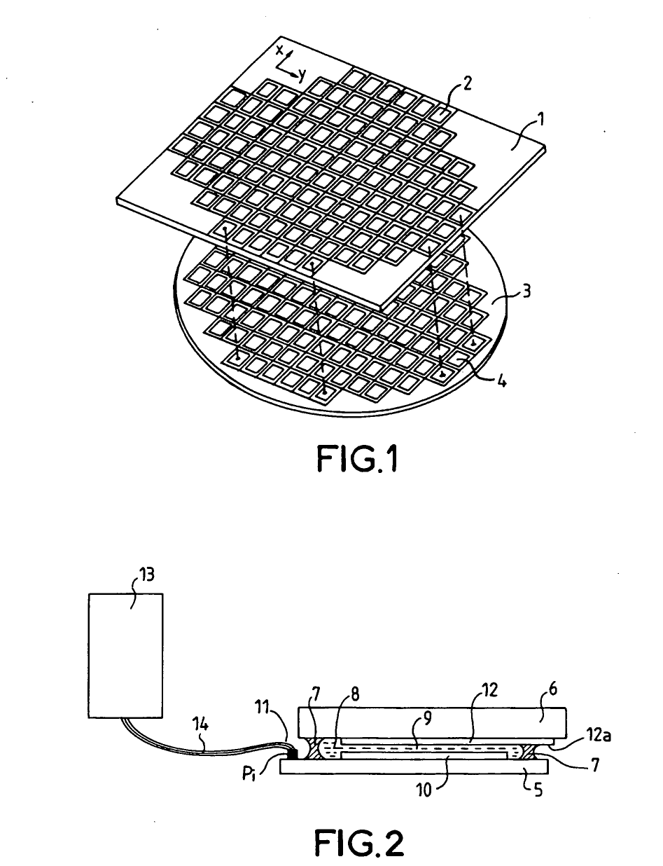

The collective assembling of the silicon and glass supports requires that the respective sizes of the individual substrates be the same on both supports. In FIG. 1 is diagrammatically represented the overlaying of a glass support 1 carrying an orthogonal array of back electrode circuits 2, and a silicon wafer 3 carrying an orthogonal array of active matrix circuits 4. The orthogonal arrays are of like dimensions (they have the same pitch in x and in y), so that when the two supports 1 and 2 are correctly aligned the one with respect to the other, each active matrix circuit 4 is facing a back electrode circuit 2. The cutting lines on each of the supports correspond to the rows and columns of the array. The two supports may be shifted the one with respect to the other along a direction x or y, so as to clear the contact pads generally provided on a peripheral edge of the active matrix circuits and the back electrodes.

Represented in FIG. 2 in a transverse view is a liquid crystal cell obtained according to a collective method. This cell is formed of a silicon substrate 5, assembled to a glass substrate 6 by means of a sealing frame 7, these three elements forming a cavity 8 which contains the liquid crystals 9.

The silicon substrate 5 comprises an active zone 10 and a peripheral zone comprising a connection zone 11. The active zone 10 is situated inside the zone delimited by the sealing frame 7 and comprises the matrix of pixel elements. The connection zone 11 is situated outside the sealing frame and comprises contact pads (Pᵢ).

The glass substrate 6 comprises a back electrode pattern 12, which defines a window through which the matrix of pixel elements is viewed. The former is positioned with respect to the silicon substrate in such a way as to clear the connection zone 11, in such a fashion as to allow the connection of the cell to a control device 13 of a display system, for example by means of a flexible printed circuit 14. Provision is generally made for the back electrode 12 to overhang the frame, in a zone 12a of the transparent substrate 6 overhanging with respect to the silicon substrate, making it possible to connect the back electrode to a control device of the cell, for example by means of a flexible printed circuit.

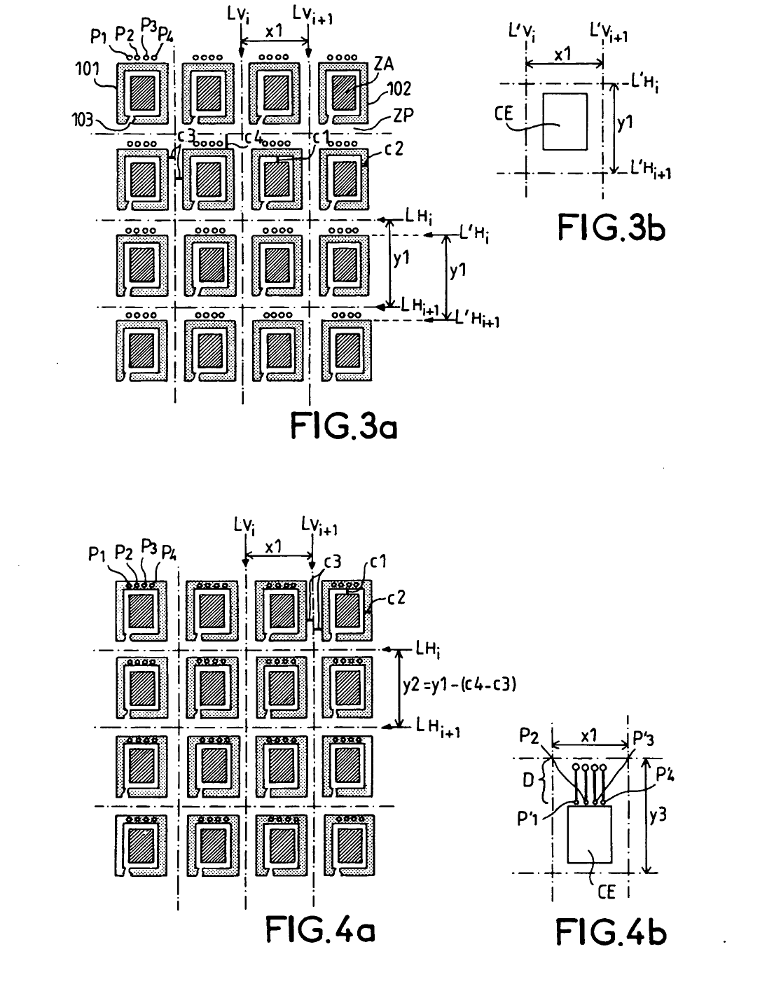

Each active matrix circuit is formed in a subdivision of the silicon wafer, that is generally called a “die” in the literature. As represented in FIG. 3a, each subdivision 100 is delimited by two adjacent vertical cutting lines LVⱼ and LVⱼ₊₁ and two adjacent horizontal cutting lines LHᵢ and LHᵢ₊₁. These lines correspond to the rows and columns of the placement array of the active matrix circuits.

Each subdivision (or individual substrate, or active matrix circuit) comprises an active zone ZA, with the pixel elements, and a peripheral zone ZP, around the active zone, which comprises contact pads, P₁, P₂, P₃, P₄. These contact pads are situated in one and the same connection zone 101, in the example, on the upper horizontal edge. These pads are intended to receive the matrix addressing signals provided by an external control device 13 of the cell, for example by means of a flexible printed circuit 14 (FIG. 2).

A sealing frame 102 is disposed around the active zone ZA. This frame, not completely closed, allows the assembly with a substrate carrying the back electrode, and the formation of a cavity between the two substrates, so as to receive the liquid crystals. In a known manner, after introduction of the liquid crystals, the opening 103 produced in the frame is closed.

The design rules devised to take account, in particular, of the tolerances on the fabrication equipment used (accuracies, alignments), impose certain minimum dimensions. For a given type of display screen, the dimensions of the corresponding active matrix circuit are known. For example, for HDTV type applications, the definition of the cell is 1920 pixels (horizontal) by 1080 pixels (vertical). With an on-silicon technology which gives a pixel area of 10×10 μm², one has a corresponding cell active zone area of the order of 207 mm². This is the functional area of the active matrix circuit. Around this zone there is a peripheral, nonfunctional zone, whose dimensions depend on the design rules, determined so as to have high reliability of fabrication, while taking account of the problems of tolerances of alignment, of thickness of deposition of adhesive seal (sealing frame) according to the technique employed (screen printing, syringe or dispenser), of thickness of the cuts, and the like. These design rules translate into minimum dimensions to be complied with, which condition the pitch of the placement array for locating the circuits on the silicon wafer.

More precisely, and referring to FIG. 3a, a first dimension c1 defines the minimum distance between the edges of the active zone ZA and the sealing frame 102; a second dimension c2 defines the minimum thickness of the sealing frame 102; a third dimension c3 defines the minimum distance between the frame 102 and a vertical cutting line LVⱼ (column of the placement array) or horizontal cutting line LHⱼ (row of the placement array); a fourth dimension c4 defines the width of minimum overlap of the connection zone 101 with respect to the sealing frame 102.

Returning to the example of a liquid crystal cell for HDTV type applications, it was seen that the cell active zone area is of the order of 207 mm², this corresponding to the share of functional area of the silicon subdivision.

The nonfunctional silicon area, corresponding to the peripheral zone ZP, and which is related to the dimensions c1 to c4, represents an area of the order of 151 mm², i.e. 42% of the total area of silicon, when taking c1=c2=0.7 mm, c3=0.5 mm and c4=1 mm.

Thus, the proportion of the nonfunctional zones in the silicon with respect to the functional zones is fairly high.

Now, silicon is an expensive material. If it is possible to reduce the proportion of nonfunctional zones, to the benefit of the functional zones in the silicon, the cost of the liquid crystal cells emanating from this technology is significantly lowered.

An object of the invention is to reduce the proportion of the nonfunctional zones of the silicon substrates in liquid crystal cells, so as to obtain a reduction in the cost of fabricating these cells.

The idea on which the invention is based is to relocate the zone of connection of the active matrix circuit onto the glass substrate. The constraint related to compliance with the fourth dimension c4 can then be dispensed with. It is then possible to reduce the silicon area necessary for each cell.

More precisely, according to the invention, the sealing frame is disposed on each active matrix circuit of the wafer, so that a portion of the frame overlaps the contact pads. The frame comprises a seal and conducting elements disposed in the seal. These conducting elements ensure electrical continuity of the contact pads on the matrix with corresponding connection means made on the transparent support. These conducting elements are also spacers (shims) which guarantee the spacing between the two substrates.

Such as characterized, the invention therefore relates to a method of fabricating a plurality of individual liquid crystal cells, each comprising a first substrate comprising a back electrode and a second active matrix substrate, which are assembled with a sealing frame producing a cavity between the two substrates for liquid crystals, the first substrates being formed collectively on a transparent support, the second substrates being formed collectively on a silicon wafer, and comprising contact pads. According to the invention
means of connection are formed on each first substrate opposite said contact pads of the second substrates;
the sealing frame is disposed between each first and second substrate of a cell, so as to overlap said contact pads, and a portion of the means of connection opposite, said frame comprising a seal and conducting elements disposed in said seal, so as to ensure electrical continuity between each pad and a corresponding element of the means of connection, and
the second substrates are cut from the silicon wafer, along cutting lines corresponding to the contour of the sealing frame,
each of said second cut substrates is transferred to and assembled on the transparent support, with a corresponding first substrate and
a subsequent step of separation into individual liquid crystal cells by cutting the glass support is performed so that the zone of each first substrate comprising the means of connection is overhanging with respect to the second substrate to which it is assembled.

A minimum silicon area is thus obtained, which makes it possible to gain around 10% of silicon area on a wafer. This is space freed up for the production of additional circuits on a silicon wafer. For example, on a wafer on which 15 rows of 9 active matrix circuits, i.e. 135 circuits, will be produced, one row of circuits will be gained, i.e. 9 circuits in the example.

The invention also relates to a liquid crystal cell, with a glass substrate carrying the back electrode and a silicon substrate comprising an active matrix circuit. According to the invention, the second substrate has a cutout corresponding to the contour of the sealing frame. The cell comprises means of connection of the active matrix circuit that are relocated onto the glass substrate, and overhang with respect to the silicon substrate, and a sealing frame which assembles the two substrates overlapping the contact pads of the silicon substrate and a portion of the relocated connection means and comprising a seal and conducting elements disposed in the seal.

Other advantages and characteristics of the invention will become more clearly apparent on reading the description which follows, offered by way of nonlimiting indication of the invention and with reference to the appended drawings, in which:

FIG. 1 illustrates the positioning for assembly of a silicon wafer with a transparent support, so as to collectively form a batch of liquid crystal cells;

FIG. 2 diagrammatically represents a resulting liquid crystal cell;

FIG. 3a diagrammatically represents a placement array for locating active matrix circuits on a silicon wafer;

FIG. 3b represents a grid square of a corresponding array of back electrode circuits on a transparent support;

FIG. 4a diagrammatically represents a placement array for locating active matrix circuits on a silicon wafer according to the invention;

FIG. 4b represents a grid square of a corresponding array of back electrode circuits on a transparent support;

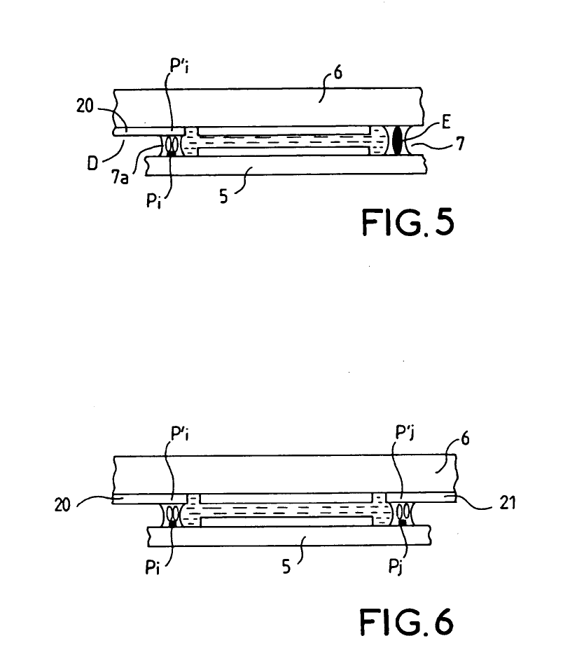

FIG. 5 represents in transverse section a resulting liquid crystal cell;

FIG. 6 diagrammatically represents another variant of liquid crystal cell according to the invention, and

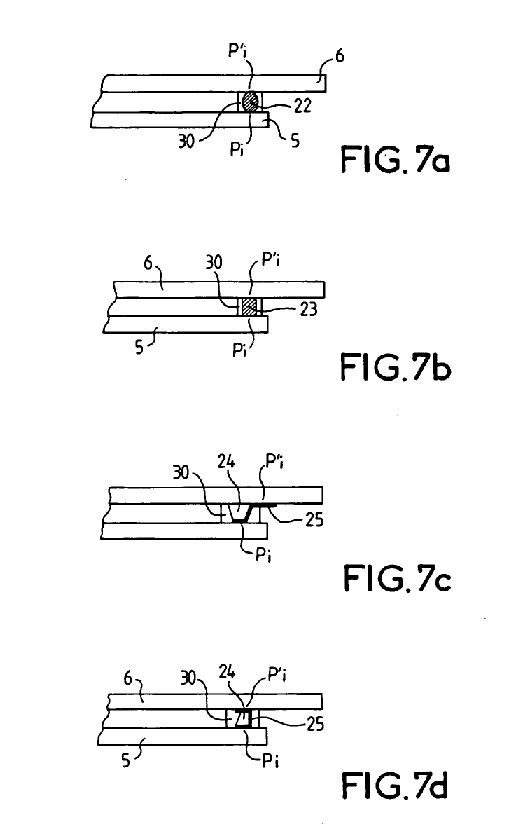

FIGS. 7a to 7d illustrate various modes of embodiment of the conducting elements according to the invention.

A liquid crystal cell obtained by applying the principle of fabrication according to the invention is illustrated in FIG. 5.

Compared with a cell of the state of the art as represented in FIG. 2, the liquid crystal cell comprises means of connection 20 of the active matrix circuit that are relocated onto the transparent substrate 6. These relocated means of connection 20 are disposed overhanging with respect to the silicon substrate. They are typically conducting tracks, for example tracks of ITO (indium tin oxide), or tracks plated with a conducting metal.

The sealing frame 7 is disposed in such a way as to overlap the contact pads Pi of the active matrix circuit, on the silicon substrate and a portion P′i opposite of the connection means 20 relocated onto the transparent substrate 6. The sealing frame is made from a seal material, such as silicone gel for example. Conducting elements 7a are disposed in the seal. Various processes for making these conducting elements may be used, and will be detailed later. Through these conducting elements 7a, the electrical continuity is ensured between each contact pad Pi of the active matrix circuit and a corresponding element P′i of the relocated means of connection 20. Through these conducting elements 7a, the spacing between the two substrates is also defined: these conducting elements are also spacers.

In a general manner, it may be noted that spacers E are generally provided over the whole perimeter of the frame. According to the invention, in the connection zones, these spacers are then embodied by the conducting elements 7a. Elsewhere may be disposed the spacers customarily used, such as balls or fibers of silica. However, elements of the same nature as the conducting elements 7a may equally well be used as spacers E.

By using connection means relocated onto the transparent substrate according to the principle of the invention, the silicon substrates can be cut along cutting lines which follow the contour of the frame, while complying with the design rules. This is what is represented in FIGS. 4a and 4b. The horizontal cutting lines LHᵢ and vertical cutting lines LVᵢ may be disposed so as to take account solely of the dimensions c1, c2 and c3. The dimension c4 is no longer applied, thereby making it possible, in the example, to gain (c4-c3), i.e. 0.3 mm in the example, on each height of circuit.

Stated otherwise, if x1 and y1 denote the distance separating two adjacent vertical and horizontal cutting lines, in the array of FIG. 3a, with an array according to the inventive principle applied to the configuration represented, the distance x1 between two adjacent vertical cutting lines is unchanged (FIG. 4a), but the distance between two adjacent horizontal cutting lines becomes y2=y1-(c4-c3).

As far as the transparent support is concerned, and as represented in FIG. 4b, each individual transparent substrate must comprise, in addition to the back electrode CE, the relocated connection means 20. These means are typically conducting tracks (ITO tracks, or metal plated tracks) and comprise pads P′₁, P′₂, P′₃, P′₄ corresponding to the pads P₁, P₂, P₃, P₄ on the silicon substrate. It is these pads which will be overlapped by the sealing frame. These pads are extended by conducting lines to other pads situated at the rim of the transparent substrate, in the zone D provided so as to be overhanging with respect to the silicon substrate, after assembly. The relocated connection means 20 may for example be embodied so as to allow an external connection of the “wire bonding” type, or a connection by thermobonding of a flexible printed circuit, with a strip of anisotropic conducting adhesive (containing nickel balls for example) applied hot between the transparent substrate and the flexible printed circuit.

The disposition of the conducting elements 7a in the seal of the sealing frame 7 (FIG. 4) is determined in such a way as to ensure electrical continuity between the contact pads which correspond to one another on the substrates, P1 and P′1 for example, but without creating short-circuits between two adjacent tags, P1 and P2 for example.

Thus, in a cell according to the invention, the control signals of the circuits placed on the silicon substrate travel exclusively through the transparent substrate, across the opposed contact zones, linked by the conducting elements of the sealing seal.

The invention furthermore makes it possible to dispose contact pads optionally on several edges, this perhaps being beneficial for the design of the active matrix circuit itself, for the disposition of the conducting lines with respect to the active elements. It is thus possible to dispose contact pads Pi on an edge, and tags Pj on another edge. Such is the case for the cell represented in FIG. 6. Provision must then be made for corresponding relocated connection means 21 on the transparent substrate 6, overhanging with respect to the silicon substrate.

With relocated connection means, and a sealing frame overlapping the contact pads of the active matrix circuit on the silicon substrate, the nonfunctional zone of the silicon substrate may be reduced. Preferably, the cutting lines therefore correspond to the contour of the sealing frame, to within the design constraints (c3).

As may be seen in FIGS. 5 and 6 and 4a and 4b, the area of the silicon substrate becomes smaller than the area of the transparent substrate onto which the means of connection of the active matrix circuit have been relocated. The cutting lines of the silicon and transparent substrates no longer coincide.

The method of fabrication therefore comprises a step of cutting the silicon wafer into active matrix individual substrates 5 and the transferring and the assembling of each of these silicon substrates onto a corresponding transparent substrate.

Before transfer and assembly, a layer of polyimide is deposited and then rubbed away on the circuits of the transparent substrate and on each of the individual silicon substrates, on the active matrix circuit, and this will allow the alignment of the liquid crystals which will be injected, in the microstriations thus formed.

After cutting of the silicon substrates, and assembly onto the transparent support, with a corresponding transparent substrate, the glass support can thereafter be cut according to the customary techniques. The liquid crystal is introduced according to any known method, then the openings in the frames are plugged. The individual liquid crystal cells are obtained.

In practice, a reduction in the silicon area of each active matrix substrate is obtained, which makes it possible to produce around 10% of extra circuits on each wafer. The costs of fabricating the liquid crystal cells are thus reduced.

Represented in FIGS. 7a to 7d are various embodiments of the conducting elements 7a disposed in the seal of the sealing frame.

In a first embodiment represented in FIG. 7a, these conducting elements are conducting balls 22. These balls may be balls of an insulating material, plated with a conducting material, for example gold, or balls of a conducting material. They are disposed at the necessary locations in the seal, by injection by means of a syringe (“dispenser”). The diameter of the balls is generally of the order of 2 microns and more. The contact pads are spaced of the order of 20 to 50 microns apart on the silicon substrate.

When the two substrates are assembled the one to the other, the silicone gel, or the adhesive which forms the material of the seal 30 is pressed, so that the ball comes directly into contact on each side on the substrates.

The diameter of the balls thus defines the gap between the two assembled substrates, that is to say the size of the cavity.

For cells with a small gap, less than 2 microns, the use of balls as conducting elements and as spacers is no longer suitable.

Represented in FIG. 7b is another embodiment of the conducting elements of the sealing frame. In this example, the conducting elements are tags 23 of a conducting material, for example aluminum. These tags may have any desired height. In particular, it is known how to make such tags with a height of 2 microns and less.

Preferably, these tags will be made on the silicon substrate, on the contact pads, by any suitable technique (photoetching). The seal may be deposited thereafter, on the silicon substrate, overlapping these tags, or on the transparent substrate. As indicated previously, when the two substrates are assembled the one to the other, the silicone gel, or the adhesive which forms the material of the seal is pressed, so that the conducting tag comes directly into contact on each side on the substrates.

Another embodiment is represented in FIGS. 7c and 7d, in which a resin tag 24, furnished with a conducting layer 25, is used as conducting element 7a.

In FIG. 7c, this resin tag 24 is produced on the transparent substrate, then a deposition of a conducting layer is carried out, which will at least overlap the face of the tag which is to come into contact with the pad Pᵢ on the silicon substrate, and which will overlap a part of the transparent substrate, on the corresponding pad P′i.

In FIG. 7d, the resin tag 24 is produced on the silicon substrate, on the contact pad Pᵢ. It is furnished with a layer of metal 25, which ensures electrical continuity between its two faces.

Here again, and in the two variant embodiments of the resin tag, when the two substrates are assembled the one to the other, the silicone gel, or the adhesive which forms the material of the seal is pressed, so that the resin tag furnished with its conducting layer comes directly into contact on each side on the substrates.

In all cases, the conducting elements 7a which ensure electrical continuity between the contact pads of the silicon substrate and the connection means relocated onto the transparent substrate, also ensure the function of spacers: they fix the gap between the two substrates, and hence the gap of the cavity.

In the other parts of the frame which do not overlap connection zones, there are also spacers E (FIG. 5). These spacers may be of any known type, such as balls or fibers of silica. These spacers may be conducting or otherwise, since they are not on connection zones. Provision may thus be made for these spacers to be of the same nature as the conducting elements 7a of the seal.

Finally, it will be noted that each transparent substrate will have a suitable shape after cutting, allowing connection of the back electrode according to any known technique.

1-10. (canceled)

11. A method of fabricating a plurality of individual liquid crystal cells, each comprising a first substrate comprising a back electrode and a second active matrix substrate, which are assembled with a sealing frame producing a cavity between the substrates for liquid crystals, the first substrates being formed collectively on a transparent support, the second substrates being formed collectively on a silicon wafer, and comprising contact pads, the method comprising:
forming means of connection on each first substrate opposite the contact pads of the second substrates;
cutting the second substrate from the silicon wafer, along cutting lines corresponding to the contour of the sealing frame;
transferring each of the second cut substrates to the transparent support and assembling each of the second cut substrates on the transparent support, with a corresponding first substrate so that the sealing frame is disposed between each first and second substrate of a cell, so as to overlap the contact pads, and an opposite portion of the means of connection, the frame comprising a seal including an insulating material and conducting elements disposed in the seal for electrical continuity between each pad and a corresponding element of the means of connection; and
separating into individual liquid crystal cells by cutting the transparent support so that a zone of each first substrate comprising the means of connection is overhanging with respect to the second substrate to which it is assembled.

12. The method of fabrication as claimed in claim 11, further comprising filling the cavities with liquid crystals.

13. The method of fabrication as claimed in claim 11, wherein the conducting elements include conducting balls.

14. The method of fabrication as claimed in claim 11, wherein the conducting elements include resin tags furnished with a conducting layer.

15. The method of fabrication as claimed in claim 11, wherein the conducting elements include metal tags produced on the silicon substrate.

16. The method of fabrication as claimed in claim 11, wherein the conducting elements include spacers.

17. The method of fabrication as claimed in claim 16, wherein other spacer elements are disposed in the seal, the other spacer elements being conducting or otherwise, and of a same nature as or of a different nature from the conducting elements.

18. A liquid crystal cell comprising:
a first transparent substrate comprising a back electrode and a second silicon substrate comprising an active matrix circuit with contact pads, the substrates being assembled with a sealing frame producing a cavity between the substrates for liquid crystals, wherein
the second substrate includes a cutout corresponding to a contour of the sealing frame,
the cell comprises means of connection of the active matrix circuit that are relocated onto the first substrate and are disposed overhanging with respect to the second substrate,
the sealing frame includes a seal that overlaps the contact pads on the second substrate and an opposite portion of the means of connection, and conducting elements disposed in the seal for electrical continuity between each of the contact pads and a corresponding portion of the means of connection.

19. The cell as claimed in claim 18, wherein the conducting elements include spacers.

20. The cell as claimed in claim 19, wherein other spacer elements are disposed in the seal, the other spacer elements being conducting or otherwise, and of a same nature as or of a different nature from the conducting elements of the seal.

21. The cell as claimed in claim 18, wherein the conducting elements include conducting balls.

22. The cell as claimed in claim 18, wherein the conducting elements include resin tags furnished with a conducting layer.

23. The cell as claimed in claim 18, wherein the conducting elements include metal tags produced on the silicon substrate.

24. A liquid crystal display comprising:
a liquid crystal cell,
wherein the liquid crystal cell comprises a first transparent substrate comprising a back electrode and a second silicon substrate comprising an active matrix circuit with contact pads, the substrates being assembled with a sealing frame producing a cavity between the substrates for liquid crystals, wherein the second substrate includes a cutout corresponding to a contour of the sealing frame,
wherein the cell comprises means of connection of the active matrix circuit that are relocated onto the first substrate and are disposed overhanging with respect to the second substrate, wherein the sealing frame includes a seal that overlaps the contact pads on the second substrate and an opposite portion of the means of connection, and conducting elements disposed in the seal for electrical continuity between each of the contact pads and a corresponding portion of the means of connection.
